(19) United States
(12) Patent Application Publication
(10) Pub. No.: US 2014/0191894 A1
(43) Pub. Date: Jul. 10, 2014

(54) THREE-DIMENSIONAL POSITIONING METHOD

(71) Applicant: NATIONAL CENTRAL UNIVERSITY, Taoyuan County (TW)

(72) Inventors: Liang-Chien Chen, Taoyuan County (TW); Chin-Jung Yang, Tainan City (TW)

(73) Assignee: National Central University, Taoyuan County (TW)

(21) Appl. No.: 13/869,451

(22) Filed: Apr. 24, 2013

(30) Foreign Application Priority Data
Jan. 4, 2013 (TW) 102100360

(51) Int. Cl. G01S 13/86

(52) U.S. Cl. CPC G01S 13/86
USPC 342/52

(57) ABSTRACT

A three-dimensional positioning method includes establishing the geometric model of optical and radar sensors, obtaining rational function conversion coefficient, refining the rational function model and positioning the three-dimensional coordinates. Most of the radar satellite companies and part of the optical satellite only provide satellite ephemeris data, rather than the rational function model. Therefore, it is necessary to obtain the rational polynomial coefficients from the geometric model of optical and radar sensors; followed by refining the rational function model by the ground control points, so that object image space intersection is more serious; and then followed by measuring the conjugate point on the optical and radar images. Finally, the observation equation is established by the rational function model to solve the three-dimensional coordinates. It is obvious from the above results that the integration of optical and radar images does achieve the three-dimensional positioning.

### BACKGROUND OF THE INVENTION

1. Field of the Invention

The present invention relates to a three-dimensional positioning method, particularly to a three-dimensional positioning method which can be applied to various satellite images in a satellite positioning system. More particularly, it relates to a three-dimension positioning method which uses a rational function model (RFM) with the integration of optical data and radar data.

2. Description of Related Art

Common information sources for surface stereo information by satellite images can be acquired by using optical images and radar images. For optical satellite images, the most common method is to use three-dimensional image pairs. For example, Gugan et al have proposed their researches about accurate and integrity for topographic mapping based on SPOT imagery (Gugan, DJ and Dowman, I J, 1988. Accuracy and completeness of topographic mapping from SPOT imagery Photogrammetric Record, 12 (72), 787-796). One pair of conjugate image points are obtained from more than two overlapped shot image pairs, and furthermore, a three-dimensional coordinate is obtained by light intersection. Leberl et al disclose radar three-dimensional mapping technology and the application of SIR-B (Leberl, F W, Domik, G Raggam J., and Kobrick M., 1986. Radar stereo mapping techniques and application to SIR-B. IEEE Transaction on Geosciences & Remote Sensing, 24 (4): 473-481) and multiple incidence angle SIR-B experiments above Argentine: three-dimensional radargrammetry Analysis (Leberl, F W, Domik, G., Raggam. J., Cimino, J., and Kobrick, M., 1986. Multiple incidence angle SIR-B experiment over Argentina: stereo-radargrammetric analysis. IEEE Transaction on Geosciences & Remote Sensing, 24 (4): 482-491). With the use of radar satellite imagery, according to the stereo-radargrammetry, one pair of conjugate image points are obtained from more than two overlapped shot radar image pairs, and furthermore, ground coordinates are obtained by distance intersection. In addition, surface three-dimensional information can be obtained from the radar images by Interferomertic Synthetic Aperture Radar (InSAR), such as the radar interference technology taking advantage of multiple radar images proposed by Zebker and Goldstein in 1986. It is confirmed that the undulating terrain can be estimated by the interferometry phase of no-load synthetic aperture radar with phase differences. Thereby, the surface three-dimensional information can be obtained.

In past researches and applications, only single type of sensor images is used as the source of acquiring the three-dimensional coordinates. For the optical images, the weather disadvantageously affects whether the images can be used or not. For the radar images, even though not affected by the weather, still has a shortage of not easy to form the three-dimensional pairs or radar interferometry conditions.

In processing the images, the prior art separately, not integrally, processes the optical images and the radar images. Therefore, the prior art cannot meet the need for the users in the actual use of integrating the use of the optical images and the radar images for three-dimensional positioning.

### SUMMARY OF THE INVENTION

A main purpose of this invention is to provide a three-dimensional positioning method with the integration of radar and optical satellite images, which can effectively improve the shortcomings of the prior art. The directional information in the optical images and the distance information in the radar images are used to integrate the geometric characteristics of the optical images and the radar images in order to achieve the three-dimensional positioning.

A secondary purpose of the invention is to provide a three-dimensional positioning method uses the standardized rational function model as basis, which allows the invention applicable to various satellite images. Furthermore, by means of unified solution, more sensor data can be integrated with good positioning performance so that this invention can be extended to the satellite positioning system.

In order to achieve the above and other objectives, the three-dimensional positioning method with the integration of radar and optical satellite images includes at least the following steps:
(A) establishing an optical image geometric model: direct georeferencing is used as a basis to establish the geometric model of the optical images;
(B) establishing a radar image geometric model: the geometric model of the radar images is established based on Range-Doppler equation;
(C) obtaining a rational polynomial coefficients: based on the rational function model, optical satellite images are subject to back projection according to virtual ground control points in a geometric model for optical images; an image coordinate corresponding to the virtual ground control points is obtained by using collinear conditions; from the geometric model for radar images, radar satellite images are subject to back projection according to the virtual ground control points; according to the distance and the Doppler equation to obtain an image coordinate corresponding to the virtual ground control points; and rational polynomial coefficients for the optical images and the radar images are generated to establish a rational function model;
(D) refining the rational function model: in the rational function model, the image coordinate is converted to a rational function space and calculated as a rational function space coordinate; the rational function space coordinate and the image coordinate according to the ground control points are used to obtain affine transformation coefficient; after the completion of the linear conversion, the system error correction is finished; and by means of least square collocation, the partial compensation is executed for amendments so as to eliminate systematic errors; and
(E) three-dimensional positioning: after the rational function model is established and refined, conjugate points are measured from the optical images and radar images; those conjugate points are put into the rational function model to establish an observing equation of three-dimensional positioning; and positioning a target at a three-dimensional spatial coordinate can be finished by least square method.

### BRIEF DESCRIPTION OF THE DRAWINGS

FIG. 1 is a schematic view of flow chart of three-dimensional positioning by means of the integration of radar and optical satellite imagery according to the present invention.

FIG. 2A is a diagram of ALOS/PRISM test images according to one embodiment of the present invention.

FIG. 2B is a diagram of SPOT-5 test images according to the present invention.

FIG. 2C is a diagram of SPOT-5 Super Mode test images according to one embodiment of the present invention.

FIG. 2D is a diagram of ALOS/PALSAR test images according to one embodiment of the present invention.

FIG. 2E is a diagram of COSMO-SkyMed test images according to one embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

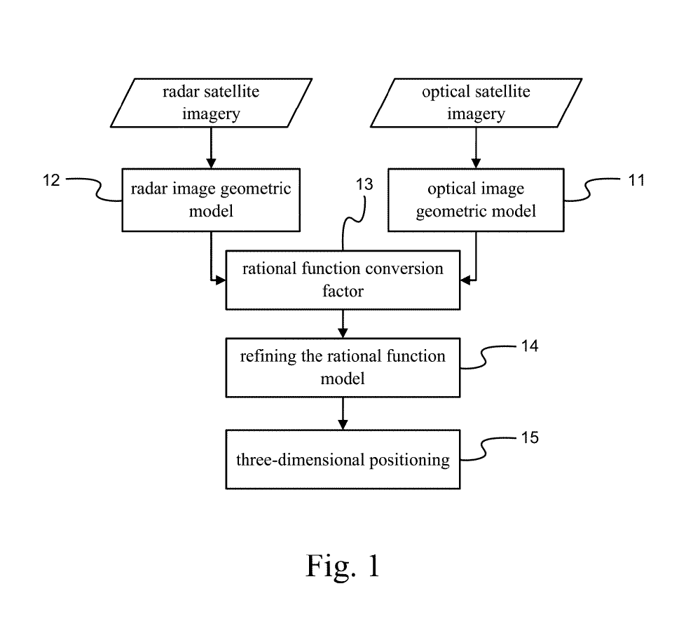

Surface three-dimensional information is essential to environmental monitoring and conservation of soil and water resources. A synthetic aperture radar (SAR) and optical imaging offer the main telemetry data for obtaining the three-dimensional information. The integration of the information from both the optical and radar sensors can get more useful information. Please refer to FIG. 1 which is a schematic view of flow chart of three-dimensional positioning by means of the integration of radar and optical satellite imagery according to the present invention. As shown, the present invention relates to a method for three-dimensional positioning by means of the integration of radar and optical satellite imagery. From the viewpoint of geometry, the data of the two heterogeneous sensors is combined to obtain the three-dimensional information at a conjugate imaging point. Prerequisite for the three-dimensional positioning measurement using satellite imagery is to establish a geometric model for linking the images with the ground. Rational function model (RFM) has the advantages of standardizing geometric models for facilitating to describe the mathematical relationship between the images with the ground. Therefore the present invention uses the rational function model to integrate the optical and radar data for three-dimensional positioning.

The method proposed in the present invention contains at least the following steps:

(A) establishing an optical image geometric model 11: Direct georeferencing is used as a basis to establish the geometric model of the optical images;

(B) establishing a radar image geometric model 12: The geometric model of the radar images is established based on Range-Doppler equation;

(C) obtaining a rational polynomial coefficients 13: Based on the rational function model, optical satellite images are subject to back projection according to virtual ground control points in a geometric model for optical images. An image coordinate corresponding to the virtual ground control points is obtained by using collinear conditions. From the geometric model for radar images, radar satellite images are subject to back projection according to the virtual ground control points. According to the distance and the Doppler equation to obtain an image coordinate corresponding to the virtual ground control points. Thereby, rational polynomial coefficients for the optical images and the radar images are generated to establish a rational function model.

(D) refining the rational function model 14: In the rational function model, the image coordinate is converted to a rational function space and calculated as a rational function space coordinate. Then, the rational function space coordinate and the image coordinate according to the ground control points are used to obtain affine transformation coefficient. After the completion of the linear conversion, the system error correction is finished. By means of least square collocation, the partial compensation is executed for amendments so as to eliminate systematic errors; and

(E) three-dimensional positioning 15: After the rational function model is established and refined, conjugate points are measured from the optical images and radar images. Those conjugate points are put into the rational function model to establish an observing equation of three-dimensional positioning. Positioning a target at a three-dimensional spatial coordinate can be finished by least square method.

At the above step (A), optical image geometric model is established using a direct geographic counterpoint method with a mathematical formula as follows:

\vec{G}=\vec{P}+S\vec{U},

Xᵢ=X(tᵢ)+Sᵢuᵢ^{X}

Yᵢ=Y(tᵢ)+Sᵢuᵢ^{Y}

Zᵢ=z(tᵢ)+Sᵢuᵢ^{Z},

wherein, \vec{G} is a vector from Earth centroid to the ground surface; \vec{G} is a vector from Earth centroid to a satellite; Xᵢ, Yᵢ, Zᵢ are respectively ground three-dimensional coordinates; X(tᵢ), Y(tᵢ), Z(tᵢ) are satellite orbital positions; uᵢ^{X}, uᵢ^{Y}, uᵢ^{Z} are respectively image observation vectors; Sᵢ is the amount of scale; and tᵢ is time.

At the above step (B), the geometric model of the radar images based on the radar distance and Doppler equation has the mathematical formula as follows:

$$\vec{R} = \vec{G} - \vec{P} , \\ \vert \vec{R} \vert = \vert \vec{G} - \vec{P} \vert , \\ {f}_{d} = - \frac{2}{λ} \frac{d \vec{R}}{d t} ,$$

wherein \vec{R} is a vector from the satellite to a ground point; \vec{G} is a vector from the Earth centroid to a ground point of the vector; and \vec{P} is a vector from the Earth centroid to a satellite.

The rational function model at the above step (C) can be obtained by getting rational polynomial coefficients according to a large number of virtual ground control points and the least square method, based on the rational function model. The mathematical formula is as follows:

$${S}_{RFM} = \frac{{p}_{a} ( X , Y , Z )}{{p}_{b} ( X , Y , Z )} = \frac{{\sum }_{i = 0}^{i = 3} {\sum }_{j = 0}^{j = 3} {\sum }_{k = 0}^{k = 3} {a}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {b}_{ijk} {X}^{i} {Y}^{j} {Z}^{k}}$$

$${L}_{RFM} = \frac{{p}_{c} ( X , Y , Z )}{{p}_{d} ( X , Y , Z )} = \frac{{\sum }_{i = 0}^{i = 3} {\sum }_{j = 0}^{j = 3} {\sum }_{k = 0}^{k = 3} {c}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {d}_{ijk} {X}^{i} {Y}^{j} {Z}^{k}} ,$$

wherein aᵢⱼₖ, bᵢⱼₖ, cᵢⱼₖ, dᵢⱼₖ and are respectively rational polynomial coefficients.

At the above step (D), the rational function model is refined by correcting the rational function model via affine transformation. The mathematical formula is as follows:

Ŝ=A₀×S_{RFM}+A₁×L_{RFM}+A₂

\hat{L}=A₃×S_{RFM}+A₄×L_{RFM}+A₅

wherein Ŝ and \hat{L} are respectively corrected image coordinates; and A_{0˜5} are affine conversion coefficients.

At the above step (E), the observation equation of the three-dimensional positioning has mathematical formula as follows:

$$[ \begin{matrix}{υ}_{S}^{1} \\ {υ}_{L}^{1} \\ {υ}_{S}^{2} \\ {υ}_{L}^{2}\end{matrix} ] = [ \begin{matrix}\frac{\partial {S}_{1}}{\partial X} & \frac{\partial {S}_{1}}{\partial Y} & \frac{\partial {S}_{1}}{\partial Z} \\ \frac{\partial {L}_{1}}{\partial X} & \frac{\partial {L}_{1}}{\partial Y} & \frac{\partial {L}_{1}}{\partial Z} \\ \frac{\partial {S}_{2}}{\partial X} & \frac{\partial {S}_{2}}{\partial Y} & \frac{\partial {S}_{2}}{\partial Z} \\ \frac{\partial {L}_{2}}{\partial X} & \frac{\partial {L}_{2}}{\partial Y} & \frac{\partial {L}_{2}}{\partial Z}\end{matrix} ] [ \begin{matrix}d X \\ d Y \\ d Z\end{matrix} ] + [ \begin{matrix}{\hat{S}}_{1} - {S}_{1} \\ {\hat{L}}_{1} - {L}_{1} \\ {\hat{S}}_{2} - {S}_{2} \\ {\hat{L}}_{2} - {L}_{2}\end{matrix} ] .$$

Thereby, a novel three-dimensional positioning method with integration of a radar and optical satellite imagery is achieved.

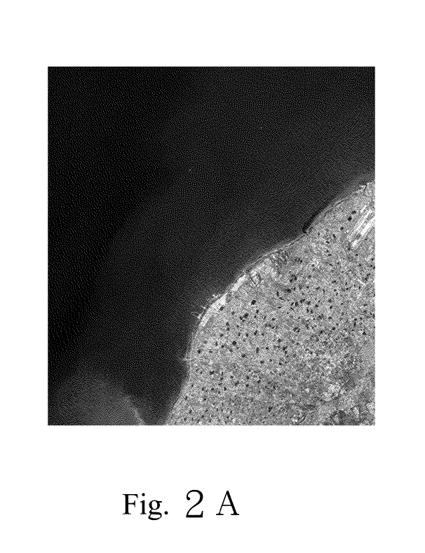

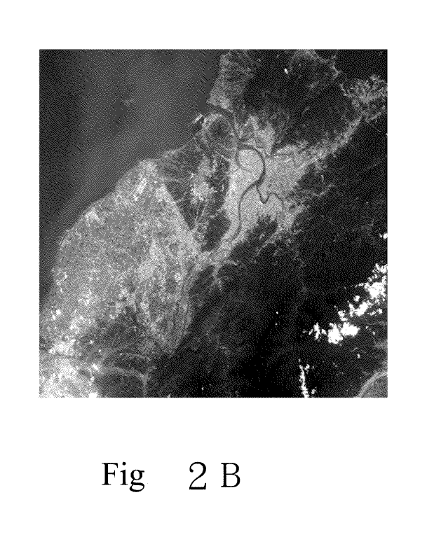

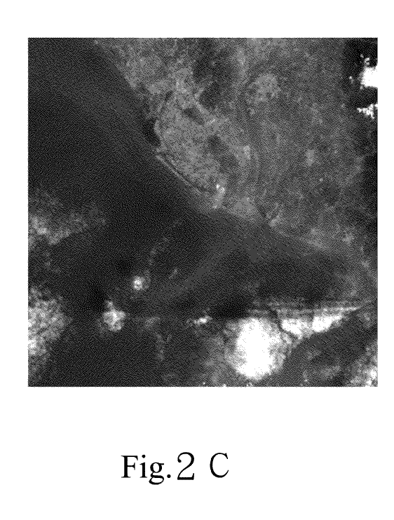

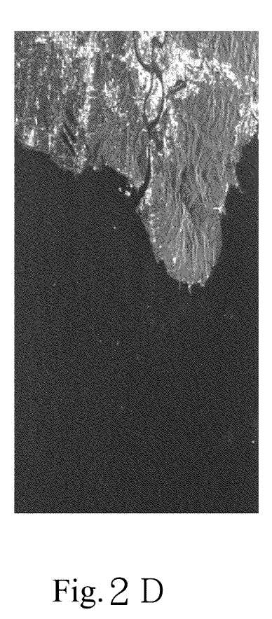

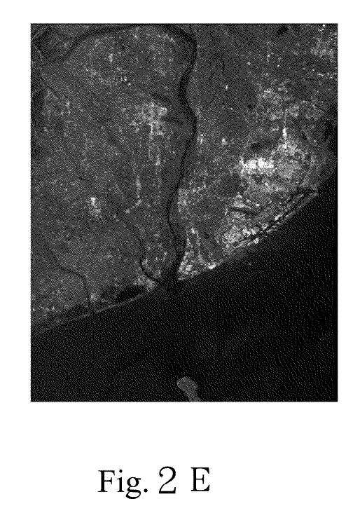

Please refer to FIG. 2A˜FIG. 2E. FIG. 2A is a diagram of ALOS/PRISM test images according to one embodiment of the present invention. FIG. 2B is a diagram of SPOT-5 test images according to the present invention. FIG. 2C is a diagram of SPOT-5 Super Mode test images according to one embodiment of the present invention. FIG. 2D is a diagram of ALOS/PALSAR test images according to one embodiment of the present invention. FIG. 2E is a diagram of COSMO-SkyMed test images according to one embodiment of the present invention. As shown, the present invention uses test images containing two radar satellite images ALOS/PALSAR and COSMO-SkyMed, and three optical satellite images (ALOS/PRISM, SPOT-5 panchromatic images and SPOT-5 Super mode image) for positioning error analysis, as shown in FIG. 2A˜FIG. 2E.

Results of positioning error analysis are shown in Table 1. From Table 1 it can be found that the integration of radar and optical satellite can achieve positioning, while the combinations of SPOT-5 and COSMO-SkyMed can achieve the positioning with accuracy of about 5 meters.

TABLE 1

| | East-west | north-south | |
|---|---|---|---|
| | direction | direction | elevation |
| ALOS/PALSAR | 3.98 | 4.36 | 13.21 |
| ALOS/PRISM | | | |
| ALOS/PALSAR | 9.14 | 4.91 | 13.74 |
| SPOT-5 | | | |
| panchromatic | | | |
| image | | | |
| COSMO-SkyMed | 4.11 | 3.54 | 5.11 |
| SPOT-5 Super | | | |
| Resolution mode | | | |
| image | | | |

Unit: m

The method proposed by the present invention has main processing steps including establishing the geometric model of optical and radar sensors, obtaining rational polynomial coefficients, refining the rational function model and positioning the three-dimensional coordinates. Most of the radar satellite companies and part of the optical satellite only provide satellite ephemeris data, rather than the rational function model. Therefore, it is necessary to obtain the rational polynomial coefficients from the geometric model of optical and radar sensors; followed by refining the rational function model by the ground control points, so that object image space intersection is more serious; and then followed by measuring the conjugate point on the optical and radar images. Finally, the observation equation is established by the rational function model to solve the three-dimensional coordinates. It is obvious from the above results that the integration of optical and radar images does achieve the three-dimensional positioning

Compared to traditional technology, the present invention has the following advantages and features.

First, in order to unify the solution of the mathematical model according to the present invention, both the optical and radar heterogenic images can be applied to the same calculation method.

Secondly, the present invention uses the optical and radar images to obtain the three-dimensional coordinates. Therefore, the invention can be more compatible to various ways to obtain the coordinates, enhancing the opportunity for the three-dimensional positioning; and

Finally, the present invention is a universal solution, using the standardized rational function model for integration, regardless of homogeneity or heterogeneity of the images. All images can use this method for three-dimensional positioning

In summary, the present invention relates to a three-dimensional positioning method with the integration of radar and optical satellite images, which can effectively improve the shortcomings of the prior art. The directional information in the optical images and the distance information in the radar images are used to integrate the geometric characteristics of the optical images and the radar images in order to achieve the three-dimensional positioning. Unlike the prior art, the invention not only uses the combination of optical or radar images, but also uses the standardized rational function model as basis, which allows the invention applicable to various satellite images. Furthermore, by means of unified solution, more sensor data can be integrated with good positioning performance so that this invention can be extended to the satellite positioning system, and thus be more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A three-dimensional positioning method with the integration of radar and optical satellite images, comprising at least the following steps:
(A) establishing an optical image geometric model: direct georeferencing is used as a basis to establish the geometric model of the optical images;
(B) establishing a radar image geometric model: the geometric model of the radar images is established based on Range-Doppler equation;
(C) obtaining a rational polynomial coefficients: based on the rational function model, optical satellite images are subject to back projection according to virtual ground control points in a geometric model for optical images; an image coordinate corresponding to the virtual ground control points is obtained by using collinear conditions; from the geometric model for radar images, radar satellite images are subject to back projection according to the virtual ground control points; according to the distance and the Doppler equation to obtain an image coordinate corresponding to the virtual ground control points; and rational polynomial coefficients for the optical images and the radar images are generated to establish a rational function model;
(D) refining the rational function model: in the rational function model, the image coordinate is converted to a rational function space and calculated as a rational function space coordinate; the rational function space coordinate and the image coordinate according to the ground control points are used to obtain affine conversion coefficient; after the completion of the linear conversion, the system error correction is finished; and by means of least square collocation, the partial compensation is executed for amendments so as to eliminate systematic errors; and
(E) three-dimensional positioning: after the rational function model is established and refined, conjugate points are measured from the optical images and radar images; those conjugate points are put into the rational function model to establish an observing equation of three-dimensional positioning; and positioning a target at a three-dimensional spatial coordinate can be finished by least square method.

2. The method of claim 1, wherein at the above step (A), optical image geometric model is established using a direct geographic counterpoint method with a mathematical formula is as follows:
\vec{G}=\vec{P}+S\vec{U},
Xᵢ=X(tᵢ)+Sᵢuᵢ^{X}
Yᵢ=Y(tᵢ)+Sᵢuᵢ^{Y}
Zᵢ=z(tᵢ)+Sᵢuᵢ^{Z},
wherein, \vec{G} is a vector from Earth centroid to the ground surface; \vec{P} is a vector from Earth centroid to a satellite; Xᵢ, Yᵢ, Zᵢ are respectively ground three-dimensional coordinates; X(tᵢ), Y(tᵢ), Z(tᵢ) are satellite orbital positions; uᵢ^{X}, uᵢ^{Y}, uᵢ^{Z} are respectively image observation vectors; Sᵢ is the amount of scale; and tᵢ is time.

3. The method of claim 1, wherein the above step (B), the geometric model of the radar images based on the radar distance and Doppler equation has the mathematical formula as follows:
$$\vec{R} = \vec{G} - \vec{P} , \\ \vert \vec{R} \vert = \vert \vec{G} - \vec{P} \vert , \\ {f}_{d} = - \frac{2}{λ} \frac{d \vec{R}}{d t} ,$$
wherein \vec{R} is a vector from the satellite to a ground point; \vec{G} is a vector from the Earth centroid to a ground point of the vector; and \vec{P} is a vector from the Earth centroid to a satellite.

4. The method of claim 1, wherein the rational function model at the step (C) is obtained by getting rational polynomial coefficients according to a large number of virtual ground control points and the least square method, based on the rational function model with a mathematical formula as follows:
$${S}_{RFM} = \frac{{p}_{a} ( X , Y , Z )}{{p}_{b} ( X , Y , Z )} = \frac{{\sum }_{i = 0}^{i = 3} {\sum }_{j = 0}^{j = 3} {\sum }_{k = 0}^{k = 3} {a}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {b}_{ijk} {X}^{i} {Y}^{j} {Z}^{k}}$$
$${L}_{RFM} = \frac{{p}_{c} ( X , Y , Z )}{{p}_{d} ( X , Y , Z )} = \frac{{\sum }_{i = 0}^{i = 3} {\sum }_{j = 0}^{j = 3} {\sum }_{k = 0}^{k = 3} {c}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {d}_{ijk} {X}^{i} {Y}^{j} {Z}^{k}} ,$$
wherein aᵢⱼₖ, bᵢⱼₖ, cᵢⱼₖ and dᵢⱼₖ are respectively rational function coefficients.

5. The method of claim 1, wherein at the step (D), the rational function model is refined by correcting the rational function model via affine transformation with a mathematical formula as follows:
Ŝ=A₀×S_{RFM}+A₁×L_{RFM}+A₂
\hat{L}=A₃×S_{RFM}+A₄×L_{RFM}+A₅
wherein Ŝ and \hat{L} are respectively corrected image coordinates; and A_{0˜5} are affine conversion coefficients.

6. The method of claim 1, wherein at the step (E), the observation equation of the three-dimensional positioning has a mathematical formula as follows:
$$[ \begin{matrix}{υ}_{S}^{1} \\ {υ}_{L}^{1} \\ {υ}_{S}^{2} \\ {υ}_{L}^{2}\end{matrix} ] = [ \begin{matrix}\frac{\partial {S}_{1}}{\partial X} & \frac{\partial {S}_{1}}{\partial Y} & \frac{\partial {S}_{1}}{\partial Z} \\ \frac{\partial {L}_{1}}{\partial X} & \frac{\partial {L}_{1}}{\partial Y} & \frac{\partial {L}_{1}}{\partial Z} \\ \frac{\partial {S}_{2}}{\partial X} & \frac{\partial {S}_{2}}{\partial Y} & \frac{\partial {S}_{2}}{\partial Z} \\ \frac{\partial {L}_{2}}{\partial X} & \frac{\partial {L}_{2}}{\partial Y} & \frac{\partial {L}_{2}}{\partial Z}\end{matrix} ] [ \begin{matrix}d X \\ d Y \\ d Z\end{matrix} ] + [ \begin{matrix}{\hat{S}}_{1} - {S}_{1} \\ {\hat{L}}_{1} - {L}_{1} \\ {\hat{S}}_{2} - {S}_{2} \\ {\hat{L}}_{2} - {L}_{2}\end{matrix} ] .$$
